(19) United States
(12) Patent Application Publication
(10) Pub. No.: US 2002/0046207 A1
(43) Pub. Date: Apr. 18, 2002

(54) Information distribution system, information distribution method, and computer program for implementing the method

(75) Inventors: Tatsuya Chino, Shiojiri-shi (JP); Hiroshi Matsumoto, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Shinjuku-ku (JP)

(21) Appl. No.: 09/887,059

(22) Filed: Jun. 25, 2001

(30) Foreign Application Priority Data
Jun. 30, 2000 (JP) 2000-199364

(51) Int. Cl. G06F 7/00; G06F 17/30

(52) U.S. Cl. 707/3

(57) ABSTRACT

An information distribution system (1) for distributing a desired information answering a request information on at least one of a plurality of displays (4, 6A, 6B) in response to a request information outputted by a mobile terminal (3) requesting the desired information includes a terminal location information collector (131) for collecting a location information of the mobile terminal (3), a display selector (121) for selecting at least one of the displays (4, 6A, 6B) based on the location information of the mobile terminal (3) and an information distributor (122) for distributing a desired information in response to the request information on the selected display (4, 6A, 6B), so that the desired information can be browsed by selecting the displays (4, 6A, 6B) in accordance with information volume, thus enhancing usability for a user.

### BACKGROUND OF THE INVENTION

1. Field Of The Invention

The present invention relates to an information distribution system, an information distribution method and a computer program for implementing the method, which distribute a desired information in response to a request information outputted from a mobile terminal on a display out of a plurality of displays.

2. Description Of Related Art

Recently, an information distribution system having an interactively communicatable multimedia information terminal installed at a public space of station and tourist spot etc. has come to be used, where users such as tourists operate the multimedia information terminal to transmit a request information requesting necessary information so that a desired information is displayed on the multimedia information terminal. The information distribution system is composed of the above-described multimedia information terminal and a network-connected server, where appropriate information in accordance with the needs of the users can be provided with various information stored on the server.

However, in the information distribution system, since the multimedia information terminal fixed at the public space has to be operated, the user has to go to the place installed with the multimedia information terminal, so that the information distribution system cannot be used by the users irrespective of time and place.

Further, since the information is provided only by the display annexed to the multimedia information terminal, it is difficult to freely arrange the information display range in accordance with density of the information volume of the service information and to provide information easy for the user to check.

### SUMMARY OF THE INVENTION

An object of the present invention is to provide an information distribution system, an information distribution method and a computer program for implementing the method capable of being used without being influenced by time and place and capable of recognizing the contents.

An information distribution system according to the present invention is for distributing a desired information answering a request information on at least one of a plurality of displays based on the request information outputted by a mobile terminal, the system having: a terminal location information collector for collecting a location information of the mobile terminal; a display selector for selecting at least one of the displays based on the location information of the mobile terminal collected by the terminal location information collector; and an information distributor for distributing the desired information answering the request information on the display selected by the display selector.

An information distribution system according to another aspect of the present invention is for distributing a desired information answering a request information on at least one of a plurality of displays based on the request information outputted by a mobile terminal, the system having: a display selector for selecting at least one of the plurality of displays based on display designation information contained in the request information; and an information distributor for distributing the desired information answering the request information on the display selected by the display selector.

In the above arrangements, the information distribution system may include a terminal location information collector for collecting a location information of the mobile terminal.

The mobile terminal refers to a handy information terminal which can be carried by the users and can transmit the present location of the users and the request information, such as a cellular phone, PDA (Personal Digital Assistants) having communication function, and a navigator.

The display refers to, besides the mobile terminal, an image display and multimedia information display installed in public space etc., which may be, for instance, large-size PDP (Plasma Display Panel) installed at station squares, a projection system for forming projection image on building exterior and windows, liquid crystal displays installed at station squares and sightseeing spots as a multimedia information terminal and liquid crystal displays installed inside of transport facilities such as trains and buses.

The information distribution system of the present invention may be constructed as a network system where a mobile terminal carried by a user, a terminal device annexed to a display and a server computer are connected via network such as the Internet, the terminal location information collector, the display selector and the information distributor being provided on the server computer.

According to the above arrangement, since the display selector selects the displays based on the location information of the mobile terminal obtained by the terminal location information collector and/or the display designation information contained in the request information, the information corresponding to the request information can be displayed on the displays provided at the public space, so that the information distribution system can be used without being influenced by time and place.

By selecting the image displays, the image information in accordance with information volume can be obtained, so that the contents of the information can be more easily caught by the users.

Since the terminal location information collector is provided, the information can be distributed by deleting unnecessary information in accordance with current location of the user having the mobile terminal, so that only the information which can be actually used by the user can be provided, thus improving usability of the information distribution system for the user.

In the above, a location information storage for storing the location information of the mobile terminal collected by the terminal location information collector may preferably be provided.

Since the location information storage for storing the location information collected by the terminal location information collector is provided, collection of the current location of the mobile terminal by the terminal location information collector, selection of the displays by the display selector and information distribution by the information distributor can be independently conducted. In other words, since display selection and information distribution is not necessarily conducted after collecting the location information, the process in the respective components of the information distribution system can be independently conducted, thus improving efficiency of the respective processes.

When the above arrangement of information distribution system has a display location information collector for collecting a location information of the display, the display selector may preferably select the display based on the location information collected by the display location information collector.

Since the display location information collector is provided so that the display selector can automatically select the displays adjacent to the user having the mobile terminal, desired information in accordance with request information can be displayed on the adjacent displays without requiring the user to include the display designation information, thus enhancing convenience for the user. In addition, since the location of the displays can be constantly checked on the server side, the new image displays to be incorporated into the information distribution system can be easily registered and administered.

In the above arrangement of the information distribution system, a distribution information storage for storing the distribution information in order to distribute the desired information in response to the request information may preferably be provided.

The distribution information may be stored by storing information provided by tourist information center, shop for selling products or providing services.

Since the distribution information storage is provided, appropriate information restricted time and area can be distributed in accordance with the request information transmitted from the mobile terminal, so that convenience for the user can be further enhanced.

In the above arrangement of the information distribution system, an identification information corresponding to the desired information may preferably be stored in the distribution information storage.

The identification information refers to information for identifying the user carrying the mobile terminal.

Since the identification information corresponding to the desired distribution information is stored, appropriate information in accordance with needs of the user can be provided, thus improving usability of the information distribution system for the users.

The present invention can be arranged not only as the above-described information distribution system, but may be arranged as an information distribution method having an information collecting step, a display selecting step, and a information distribution step, and a computer program for implementing the method, where the same functions and effects can be obtained.

According to the information distribution method of the present invention, the respective steps may not necessarily be performed by a single computer constituting the network but all the steps may be implemented with combination of a plurality of computers. Further, according to the computer program of the present invention, since the system of the present invention can be constructed using a commercial computer, the applicability of the present invention can be greatly extended.

### BRIEF DESCRIPTION OF THE DRAWINGS

FIG. 1 is a schematic drawing showing a setup of information distribution system according to an embodiment of the present invention;

FIG. 2 is a block diagram showing an arrangement of a server constituting the information distribution system according to the aforesaid embodiment;

FIG. 3 is a conceptual illustration showing a structure of a database of distribution information stored in distribution information storage of the aforesaid embodiment;

FIG. 4 is a conceptual illustration showing a location information stored in a location information storage of the aforesaid embodiment;

FIG. 5 is a flowchart showing a function of the information distribution system of the aforesaid embodiment;

FIG. 6 is a flowchart showing a function of the information distribution system of the aforesaid embodiment; and

FIG. 7 is an example of a screen displayed in the information distribution system of the aforesaid embodiment.

### DETAILED DESCRIPTION OF PREFERRED EMBODIMENT(S)

An embodiment of the present invention will be described below with reference to attached drawing.

### Arrangement Of Information Distribution System

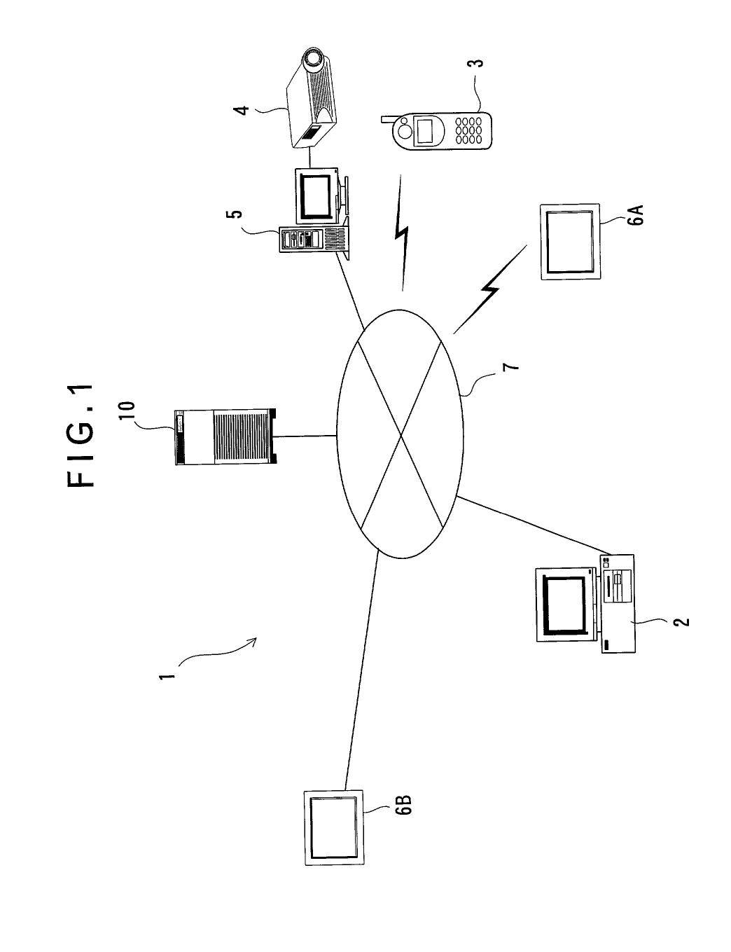

FIG. 1 shows an information distribution system 1 according to an embodiment of the present invention. The information distribution system 1 has a service terminal computer 2, a mobile terminal 3, an image display 4 and a terminal computer 5 annexed to the image display 4, image displays 6A and 6B, and a server 10, which are connected through a network 7 such as the Internet.

The service terminal computer 2 is a device for inputting information into a below-described distribution information storage 22 to which a shop proprietor inputs guide information on the shop of his own or a tourist information center inputs guide information on the sights to see on the area. The service terminal computer 2 includes a processor such as CPU (Central Processing Unit) and a storage, and is installed with a web browser operated on an OS (Operating System) for controlling the function of the CPU to be connectable with the network 7 by a modem etc. through a public circuit.

The mobile terminal 3 is a handy information terminal having communication function for the user to transmit the request information, which may be a cellular phone having web-accessing function or PDA etc. The mobile terminal 3 uses, for instance, following system for obtaining the location information of the mobile terminal 3 by the server 10. The mobile terminal 3 may have GPS (Global Positioning System) function, so that the mobile terminal 3 can periodically output latitude information and longitude information of the present location. Alternatively, using receiving base station constituting PHS, the signal outputted from the mobile terminal 3 may be received by a plurality of the base station, so that approximate location information of the mobile terminal 3 may be obtained based on the receiving condition of the plurality of the base station, which is outputted to the server 10.

In order to request the information with the mobile terminal 3, the web-accessing function of the mobile terminal 3 is used. Specifically, the mobile terminal 3 is operated to access the server through the network 7, so that desired information is selected while viewing the menu displayed on the image display of the mobile terminal 3. Incidentally, the information request by the mobile terminal 3 may be conducted according to an operation similar to facsimile service of the cellular phone. Or alternatively, the information may be requested using combination of the web-accessing function and facsimile service function.

The image display 4 and the terminal computer 5 are arranged as a projection system provided at a public space such as station and park. The information outputted by the server 10 is inputted to the terminal computer 5 through the network 7 and the modem, which is displayed as a large-screen projection image by the image display 4.

The image display 6A is composed of liquid crystal display etc., which is provided in a public traffic facilities such as train and bus, the image display 6A displaying distribution information outputted from the server 10 in the same manner as the image display 4. Incidentally, the image display 6A periodically outputs the location information thereof to the server 10. Though specifically described below, the location information thereof is periodically outputted to the server 10 through the network 7 using, for instance, a communication system of traffic facilities. On the other hand, though the image display 6B is composed of liquid crystal display etc., the image display 6B also functions as a multimedia information terminal, which can directly exchange information with the server 10 by operating an input device (not shown) annexed to the image display 6B. Incidentally, ID number of the image displays 4, 6A and 6B are displayed on the display screen of the image displays 4, 6A and 6B, so that the users can designate the image displays 4, 6A and 6B using the ID number.

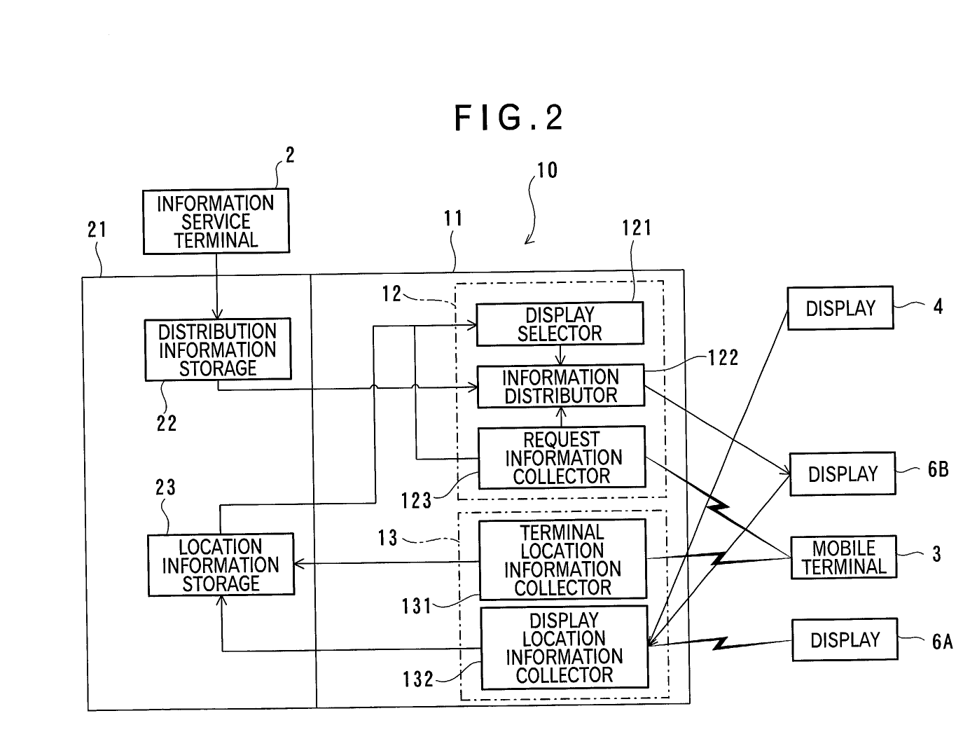

As shown in FIG. 2, the server 10 has a CPU 11 and a storage 21, and further includes a distribution information output 12 and a location information collector 13 arranged as a computer program on an OS having multi-task function for controlling the function of the CPU 11, and a distribution information storage 22 and a location information storage 23 arranged in the storage 21.

The distribution information output 12 has a display selector 121, an information distributor 122 and a request information collector 123.

The request information collector 123 collects the request information outputted by the mobile terminal 3. In the collected request information, display designation information for designating the image displays 4, 6A and 6B is outputted to the display selector 121 and the request information as to specific contents of the information is outputted to the information distributor 122.

The display selector 121 selects the image displays 4, 6A and 6B for displaying the distribution information of which distribution is requested by the user based on the display designation information outputted by the request information collector 123 and/or location information of the mobile terminal 3 stored in below-described location information storage 23. Incidentally, the display selector 121 conducts selection by obtaining and considering current location information of the image display 6A mounted on train, bus etc. from the location information storage 23.

The information distributor 122 obtains distribution information stored in the distribution information storage 22 based on the request information as to the contents of the specific information from the request information collector 123 and displays the distribution information to the image displays 4, 6A and 6B selected by the display selector 121.

The location information collector 13 collects the location information of the moving mobile terminal 3 and the image displays 6A and 6B, which is composed of a terminal location information collector 131 and a display location information collector 132.

The terminal location information collector 131 obtains the location information of the mobile terminal 3 when the user connects to the server 10 for requesting the information. When there is no information request, the location information of the mobile terminal 3 is not collected.

The display location information collector 132 periodically obtains the current location information outputted by the image display 6A. Since it is not known when the information is requested, the current location of the image display 6A has to be successively recognized. Incidentally, though the interval for the display location information collector 132 to collect the location information may be determined as desired, the collection interval may preferably be set within one minute.

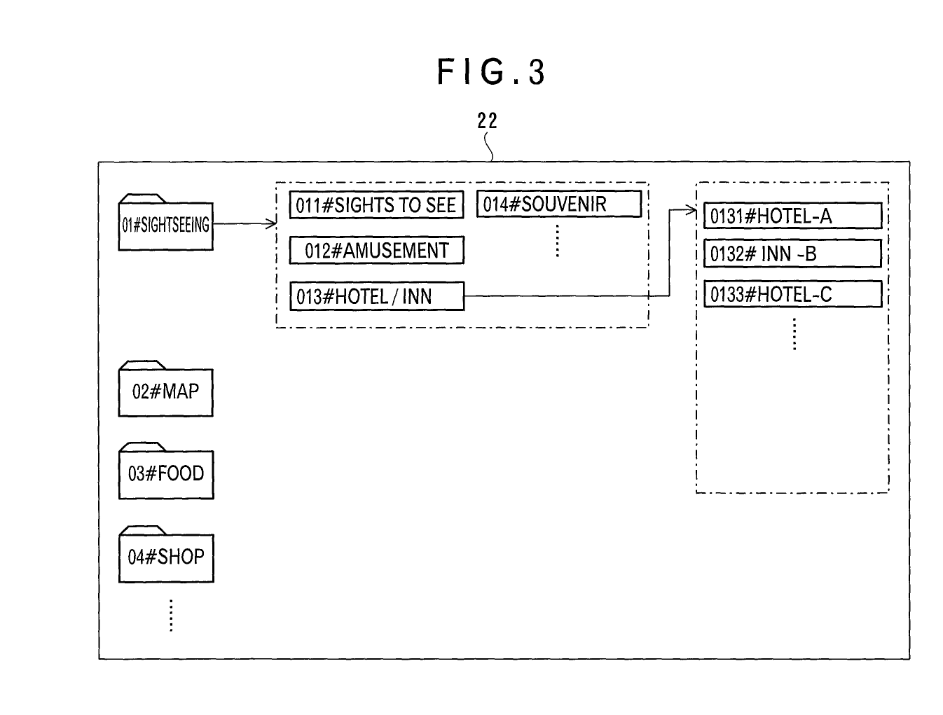

The distribution storage 22 stores the distribution information in advance for providing desired information in response to request information. As shown in FIG. 3, the distribution information storage 22 is designed as a layered database, where, for instance, “01# SIGHTSEEING” group includes subgroup of “011# SIGHTS TO SEE”, “012# AMUSEMENT”, “013# HOTEL/INN” etc. The lower layer of the “013# HOTEL/INN” group includes further subgroup of specific hotels and inns. In the same manner, “02# MAP” group has layered subgroup of municipalities, name of town etc. Though not shown, an identification information corresponding to ages and sexes of the users is applied to the respective databases, thereby giving relationship between the databases.

Incidentally, as shown in FIG. 2, the information stored in the distribution information storage 22 is entered by tourist information center of the area or a shop selling goods and providing services.

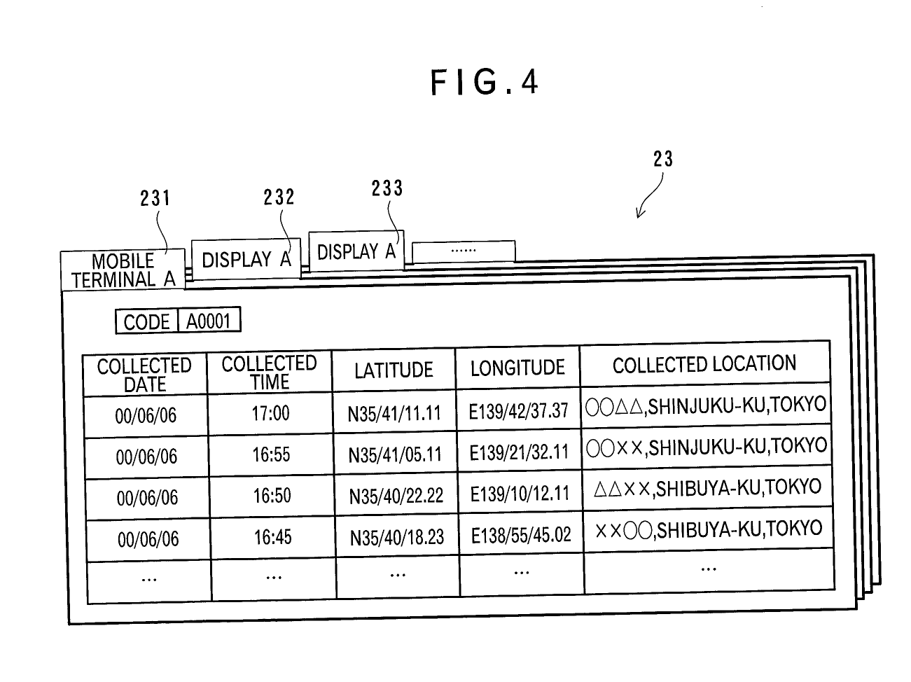

The location information storage 23 stores the current position information of the mobile terminal 3 and the image display 6A collected by the terminal position information collector 131 and the display location information collector 132, which is designed as a database having a plurality of tables 231, 232 and 233 corresponding to the number of user of the mobile terminal 3 and the moving image display 6A as shown in FIG. 4. Incidentally, the table is set for every mobile terminal 3 because the information may be requested while the user is moving.

The information stored in the respective tables 231, 232 and 233 is data collected date and time, latitude and longitude information at the time and the location information at the time. Incidentally, when the mobile terminal 3 has GPS function and outputs the location information using the GPS function, the latitude and longitude information are initially inputted, based on which the location information can be obtained. On the other hand, when the mobile terminal 3 uses base station of PHS, the location information calculated by a plurality of base stations is first inputted, based on which approximate latitude and longitude information is obtained.

### Function Of Information Distribution System

Next, functions of the information distribution system will be described below. Since the functions of the information distribution system 1 can be roughly classified as collection of location information and information distribution based on the request information, which are independently conducted using multi-task function of OS, the respective functions will be separately described.

### (1) Collection Of Location Information

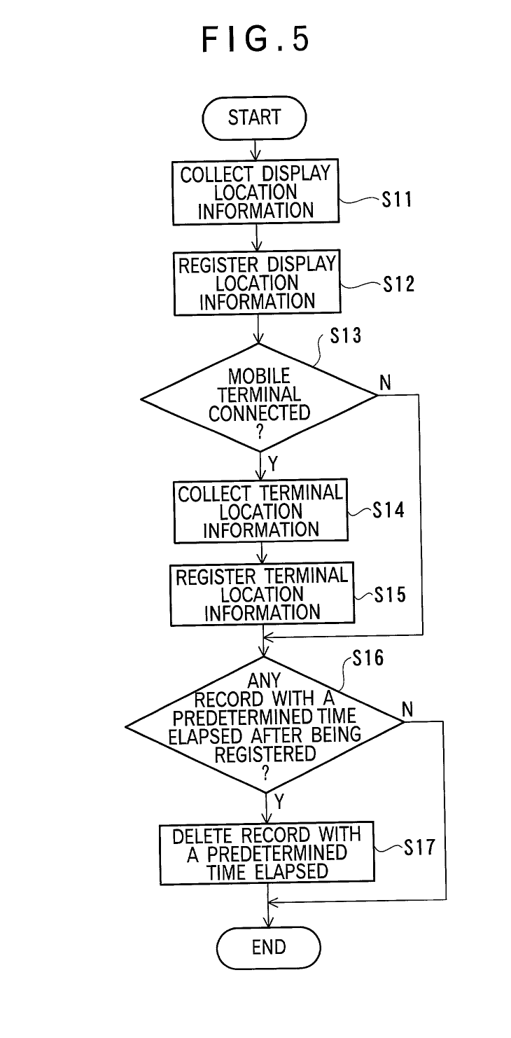

The location information will be collected based on the flowchart shown in FIG. 5.

Initially, the display location information collector 132 collects the current location information of the moving image display 6A (step S11: display location information collecting step). The information is collected by receiving transmission of the latitude and longitude information obtained from the image display 6A by GPS function or by receiving output of current location information from service management system of traffic facilities such as train and bus.

Next, the display location information collector 132 registers the collected current location information of the image display 6A in the location information storage 23 (step S12).

The terminal location information collector 131 is constantly on service to determine whether the mobile terminal 3 connects the server 10 (step S13). When the mobile terminal 3 connects to the server 10, the terminal location information collector 131 collects the current location information of the mobile terminal 3 when the connection is made (step S14: terminal location information collecting step) and registers the current location of the mobile terminal 3 into the location information storage 23 (step S15: terminal location information collecting step). Incidentally, as shown in FIG. 4, the location information collector 13 registers the current location information corresponding to predetermined time as one record for respective tables 231, 232 and 233 of the respective mobile terminal 3 and the image display 6A. Further, though the latitude and longitude information and location (address) information are recorded as the current location information, the location of public space such as station adjacent to the mobile terminal may be registered.

The location information collector 13 determines whether a predetermined time, e.g. two hours, has passed since the record of the current location registered in the respective tables 231, 232 and 233 of the location information storage 23 was collected (step S16), and sequentially deletes those records with a predetermined time elapsed (step S17). The sequential functions are continuously repeated while the server 10 is on service and the current location information of the image display 6A is renewed for every one minute interval.

### (2) Distribution of Information Based on Request Information

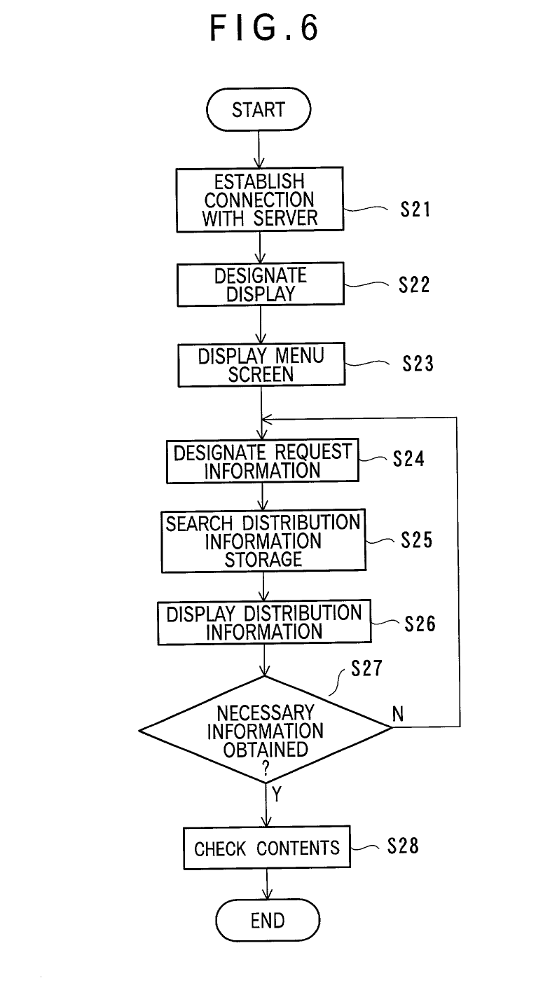

When the user searches the information stored in the server 10, the information distribution system 1 functions as shown in flowchart of FIG. 6.

Initially, the user connects with the server 10 through the network 7 by the mobile terminal 3 for transmitting request information. Web-accessing function of the mobile terminal 3 is used to establish connection with the server 10 (step S21).

After establishing the connection, the mobile terminal 3 is operated to select the displays 4, 6A and 6B to designate on which image displays 4, 6A and 6B the information is displayed (step S22). In designating the displays, the request information collector 123 displays menu of the adjacent image displays 4, 6A and 6B based on the location information of the mobile terminal 3 collected by the terminal location information collector 131 on the image display of the mobile terminal 3. The user can designate among the displayed menu or directly designate the ID number displayed on the image displays 4, 6A and 6B.

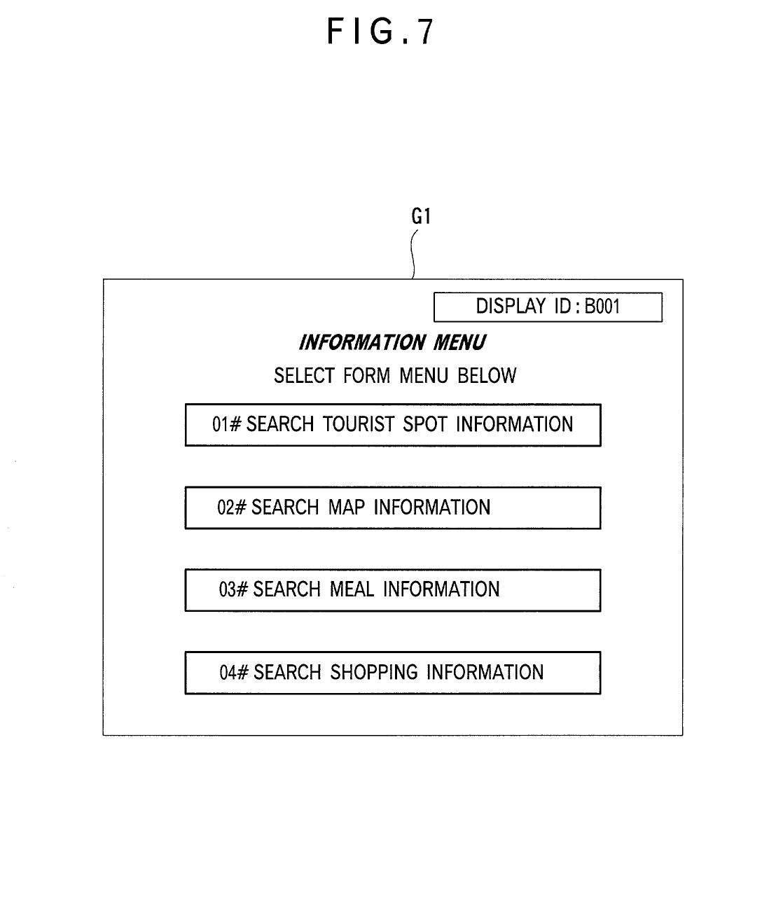

When designation information of the image display 4, 6A and 6B is inputted, the request information collector 123 outputs a signal to the information distributor 122 for displaying a menu screen G1 shown in FIG. 7 (step S23).

When the menu screen Gi is displayed on the designated image display 4, 6A and 6B, the user operates the mobile terminal 3 to designate necessary information among the menu shown in menu screen G1 while maintaining connection with the server 10 (step S24).

The request information collector 123 outputs the request information from the mobile terminal 3 to the information distributor 122. The information distributor 122 searches the distribution information storage 22 based on the request information (step S25). By the search, the information distributor 122 obtains information of ages and sexes of the user from the database (not shown) registering the information about the user of the mobile terminal 3, whereby these user information and the identification information of the respective database in the distribution information storage 22 is verified before search (user determination step). Considering the current location of the mobile terminal 3 collected by the terminal location information collector 131, the information distributor 122 does not extract an information judged meaningless in view of current location of the user, even when the information coincides with the request information (area condition determination step).

The information distributor 122 extracts and displays the distribution information corresponding to the request information (step S26: information distribution step).

The user checks whether the necessary information is obtained viewing the image displays 4, 6A and 6B (step S27). When the necessary information is not obtained, the request information is re-entered in the same manner as the above to descend to the information layer, thereby obtaining more detailed information.

When the necessary information is obtained after repeating the operation, the contents thereof are checked (step S28) and the operation is terminated.

### Effect Of The Embodiment

According to the above-described embodiment, following effects can be obtained.

Since the display selector 121 selects the image displays 4, 6A and 6B based on the display designation information outputted by user's operation of the mobile terminal 3, the information corresponding to the request information can be displayed on the image displays 4, 6A and 6B provided at the public space such as station square, so that the information distribution system 1 can be used without being influenced by time and place.

By selecting the image displays 4, 6A and 6B, the image information in accordance with information volume can be obtained, so that the contents of the information can be more easily caught by the users.

Since the terminal location information collector 131 is provided, the information can be distributed by deleting unnecessary information in accordance with current location of the user having the mobile terminal 3, so that only the information which can be actually used by the user can be provided, thus improving usability of the information distribution system 1 for the user.

Since the location information storage 23 is provided, the current location of the mobile terminal 3 and the image displays 4, 6A and 6B by the terminal location information collector 131 and the display location information collector 132 can be collected independently of selecting image displays 4, 6A and 6B by the display selector 121 and the information distributor 122, the process in the respective components of the information distribution system 1 can be independently conducted, thus improving efficiency of the respective processes.

Since the display location information collector 132 is provided so that the display selector 121 can automatically select the image displays 4, 6A and 6B adjacent to the user having the mobile terminal 3, desired information in accordance with request information can be displayed on the adjacent image displays 4, 6A and 6B without requiring the user to include the display designation information, thus enhancing convenience for the user. In addition, since the location of the image displays 4, 6A and 6B can be constantly checked on the server 10 side, the new image displays 4, 6A and 6B to be incorporated into the information distribution system 1 can be easily registered and administered.

Since the distribution information storage 22 is provided, appropriate information restricted time and area can be distributed in accordance with the request information transmitted from the mobile terminal 3, so that convenience for the user can be further enhanced.

Since the identification information is stored in the distribution information storage 22, appropriate information in accordance with ages, sexes etc. of the user can be provided, thus improving usability of the information distribution system 1 for the users.

### Modifications

Incidentally, the present invention is not restricted to the above-described embodiment, but includes following modifications.

Though the mobile terminal 3 is a cellular phone in the embodiment, but equipments such as PDA and handy navigator having communication function may be used as the mobile terminal.

Though the request information outputted from the mobile terminal 3 in the embodiment includes display designation information, the arrangement is not limited. Specifically, the display selector may automatically select the image display disposed adjacent to the mobile terminal based on the location information of the image display collected by the display location information collector so that the image display displays the distribution information in response to the request information.

Though the distribution information output 12 and the response information collector 13 are provided in a single server 10, the information distribution system of the present invention may be arranged as a system having a plurality of server.

Though the information distribution system 1 is arranged as the network 7 using a line such as the Internet, the information response system may be arranged as LAN (Local Area Network).

Though the image display 4 composed of a projector and the image display 6A and 6B composed of liquid crystal display are used as the display in the aforesaid embodiment, a display using LED and PDP etc. may be used as the image display.

The present invention is not only arranged as a system including the service terminal computer 2, the mobile terminal 3, the image displays 4 and 6 and the server 10, but may be arranged as a method for functioning the devices and, further, as a computer program for implementing the method.

Though the information is requested using web-accessing function of the mobile terminal 3 in the aforesaid embodiment, the information may be 30 requested in an operation similar to facsimile service of cellular phone.

Specifically, after three digits identifying the image display are initially inputted and “#” key is pressed, telephone number for connecting the server is inputted. Lastly, the number representing type of information requested (below-described) is inputted and the “#” key is pressed to designate the image display. After the number corresponding to a menu displayed on the image display is inputted and the request information is determined by pressing the “#” key after input operation.

Further, the request information may be transmitted by the mobile terminal 3 in a combination of the web-accessing function of the cellular phone and the facsimile service etc. Specifically, following steps can be adopted.

(1) Call specific telephone number by operating the cellular phone while designating the image display device.

(2) URL corresponding to image display is notified to the cellular phone by e-mail.

(3) When the URL is accessed from a browser of the cellular phone, information menu corresponding to the image display device is displayed on the image display of the cellular phone.

(4) The displayed information menu is selected to display the information corresponding to the request information on the image display device.

Specific arrangements and steps in implementing the present invention may be alternatively arranged as long as an object of the present invention can be achieved.

What is claimed is:

1. An information distribution system for distributing a desired information answering a request information on at least one of a plurality of displays based on the request information outputted by a mobile terminal, comprising:
a terminal location information collector for collecting a location information of the mobile terminal;
a display selector for selecting at least one of the displays based on the location information of the mobile terminal collected by the terminal location information collector; and
an information distributor for distributing the desired information answering the request information on the display selected by the display selector.

2. The information distribution system according to claim 1, further comprising a location information storage for storing the location information of the mobile terminal collected by the terminal location information collector.

3. The information distribution system according to claim 1, further comprising a display location information collector for collecting a location information of the display,
wherein the display selector selects the display based on the location information of the display collected by the display location information collector.

4. The information distribution system according to claim 1, further comprising a distribution information storage for storing the distribution information in order to distribute the desired information in response to the request information.

5. The information distribution system according to claim 4, wherein an identification information corresponding to the desired information is stored in the distribution information storage.

6. An information distribution system for distributing a desired information answering a request information on at least one of a plurality of displays based on the request information outputted by a mobile terminal, comprising:
a display selector for selecting at least one of the plurality of displays based on a display designation information contained in the request information; and
an information distributor for distributing the desired information answering the request information on the display selected by the display selector.

7. The information distribution system according to claim 6, further comprising a terminal location information collector for collecting a location information of the mobile terminal.

8. The information distribution system according to claim 7, further comprising a location information storage for storing the location information of the mobile terminal collected by the terminal location information collector.

9. The information distribution system according to claim 6, further comprising a display location information collector for collecting a location information of the display,
wherein the display selector selects the display based on the location information of the display collected by the display location information collector.

10. The information distribution system according to claim 6, further comprising a distribution information storage for storing the distribution information in order to distribute the desired information in response to the request information.

11. The information distribution system according to claim 10, wherein an identification information corresponding to the desired information is stored in the distribution information storage.

12. An information distribution method for distributing a desired information answering a request information on at least one of a plurality of displays based on the request information outputted by a mobile terminal, comprising:
terminal location information collecting step for collecting a location information of the mobile terminal;
a display selecting step for selecting at least one of the displays based on the location information of the mobile terminal collected by the terminal location information collector; and
an information distribution step for distributing the desired information answering the request information on the display selected in the display selecting step.

13. The information distribution method according to claim 12, further comprising a location information storing step for storing the location information of the mobile terminal collected in the terminal location information collecting step.

14. The information distribution method according to claim 12, further comprising a display location information collecting step for collecting a location information of the display,
wherein the display is selected in the display selecting step based on the location information of the display collected by the display location information collecting step.

15. An information distribution method for distributing a desired information answering a request information on at least one of a plurality of displays based on the request information outputted by a mobile terminal, comprising the steps of:
a display selecting step for selecting at least one of the displays based on a display designation information contained in the request information; and
an information distribution step for distributing the desired information answering the request information to the display selected in the display selecting step.

16. The information distribution method according to claim 15, further comprising a terminal location information collecting step for collecting a location information of the mobile terminal.

17. The information distribution method according to claim 16, further comprising a location information storing step for storing the location information of the mobile terminal collected in the terminal location information collecting step.

18. The information distribution method according to claim 15, further comprising a display location information collecting step for collecting a location information of the display,
wherein the display is selected in the display selecting step based on the location information of the display collected by the display location information collecting step.

19. A computer program for implementing an information distribution method according to claim 12.

20. The computer program according to claim 19, further implements storing the location information of the mobile terminal collected in the terminal location information collecting step.

21. The computer program according to claim 19, further implements collecting a location information of the display,
wherein the display is selected in the display selecting step based on the location information of the display collected by the display location information collecting step.

22. A computer program for implementing an information distribution method according to claim 14.

23. The computer program according to claim 22, further implements collecting a location information of the mobile terminal.

24. The computer program according to claim 22, further implements storing the location information of the mobile terminal collected in the terminal location information collecting step.

25. The computer program according to claim 22, further implements collecting a location information of the display,
wherein the display is selected in the display selecting step based on the location information of the display collected by the display location information collecting step.
